(19) United States
(12) Patent Application Publication
(10) Pub. No.: US 2017/0064286 A1
(43) Pub. Date: Mar. 2, 2017

(54) PARALLAX DETECTION DEVICE

(71) Applicants: DENSO CORPORATION, Kariya-city (JP); TOYOTA SCHOOL FOUNDATION, Nagoya-shi (JP)

(72) Inventors: Kazuhisa Ishimaru, Nishio-city (JP); Noriaki Shirai, Kariya-city (JP); Seiichi Mita, Nagoya (JP); Qian Long, Nagoya (JP)

(21) Appl. No.: 15/240,916

(22) Filed: Aug. 18, 2016

(30) Foreign Application Priority Data
Aug. 24, 2015 (JP) 2015-164926

(51) Int. Cl. H04N 13/02; B60R 1/00; G06T 7/00; G06K 9/00; G06T 3/40

(52) U.S. Cl. CPC H04N 13/0239; G06K 9/00791; G06T 3/40; G06T 7/00; B60R 1/00; B60R 2300/105; B60R 2300/303

(57) ABSTRACT

A parallax detection device receives right side image and a left side image, makes right and left low resolution images, and divides the right low resolution image into blocks composed of pixels. For every block, the device detects a parallax of the block by searching the block in the left low resolution image having the region the same as the region of the block of the right low resolution image by using a dynamic programming method. The device divides the right side image into blocks, and searches a resolution corresponding block in the left side image having the region the same as the region of the block for every block by using a block matching method to detect a parallax of the block. The device limits the searching range of the resolution corresponding block in the left side image based on the parallax detection result obtained by the dynamic programming method.

### CROSS-REFERENCE TO RELATED APPLICATION

This application is related to and claims priority from Japanese Patent Application No. 2015-164926 filed on Aug. 24, 2015, the contents of which are hereby incorporated by reference.

### BACKGROUND OF THE INVENTION

1. Field of the Invention

The present invention relates to parallax detection devices to be applied to distance measuring devices, capable of detecting a parallax of a target object on the basis of a plurality of images acquired detection points by in-vehicle cameras at different detection points.

2. Description of the Related Art

There has been known a distance measuring device having a parallax detection device, a first image acquiring device and a second image acquiring device such as in-vehicle stereo cameras. The distance measuring device is mounted on a vehicle, for example. In the distance measuring device, the first image acquiring device acquires a first image, and the second image acquiring device acquires a second image. The parallax detection device in the distance measuring device compares the first image and the second image, and detects a distance from the vehicle to a target object in the first image on the basis of the comparison results. The distance measuring device uses a dynamic programming method to calculate a point having a minimum value of an object function. The dynamic programming method is a known method because of being widely used. The object function includes data terms and regularization terms of the first image and the second image. The parallax detection device in the distance measuring device detects a parallax of the target object to be measured in the acquired first image on the basis of the point having the minimum value of the object function, and detects the distance from the distance measuring device to the target object on the basis of the detected parallax. For example, a patent document 1 discloses the conventional distance measuring device previously described.

However, the distance measuring device disclosed by the patent document 1 uses the object function including regularization terms, and the value of the object function rapidly varies at a point near the minimum value of the object function, and there is a possible case which provides discrete detection results of the parallax. When the detection results of the parallax become discrete values, the distance to the target object measured on the basis of the parallax becomes discrete values, and this reduces and deteriorates distance measuring accuracy of the parallax detection device in the distance measuring device.

### SUMMARY

It is therefore desired to provide a parallax detection device capable of detecting a parallax of acquired images with improved detection accuracy within a reduced processing time.

An exemplary embodiment provides a parallax detection device having a computer system including a central processing unit, i.e. a CPU. The computer system provides an image acquiring section, a low resolution image making section, a first parallax detection section and a second parallax detection section. The image acquiring section acquires a first image and a second image acquired at different image acquiring points by the image acquiring devices so that the first image and the second mage contain the same image acquiring region.

The low resolution image making section converts the first image and the second image acquired by the image acquiring section to a first low resolution image and a second low resolution image, respectively. The first low resolution image has a predetermined low resolution. The second low resolution image has the predetermined low resolution. The predetermined low resolution is lower than the resolution of each of the first image and the second image.

The first parallax detection section divides the first low resolution image into a plurality of low resolution blocks. Each of the low resolution blocks is composed of a plurality of pixels. The first parallax detection section detects a parallax of each of the low resolution blocks by searching a low resolution corresponding block in the second low resolution image, for every low resolution block of the first low resolution image by using a dynamic programming method. The low resolution corresponding block has the region which is the same as the region of the low resolution block in the first low resolution image.

The second parallax detection section divides the first image acquired by the image acquiring section into a plurality of resolution blocks. Each of the resolution blocks is composed of a plurality of pixels. The second parallax detection section determins a parallax of each of the resolution blocks by detecting a resolution corresponding block having a region which is the same as the region of the resolution block in the second image for every resolution block on the basis of a block matching method for searching the block having a high similarity of the resolution block in the second image.

The second parallax detection section limits the searching region to search the resolution corresponding blocks in the second image by using the block matching method on the basis of the parallax detection results detected by the first parallax detection section.

The structure of the parallax detection device according to the exemplary embodiment of the present invention detects the parallax by using the block matching method in addition to the dynamic programming method. Accordingly, it is possible for the parallax detection device to avoid the parallax detection results being discontinuous which is often caused by a target function containing regularization terms during the examination by the dynamic programming method. This makes it possible to increase the parallax detection accuracy of the parallax detection device.

Further, the structure of the parallax detection device according to the exemplary embodiment of the present invention uses the dynamic programming method for processing the first low resolution image which has been converted from the first image and the second low resolution image which has been converted from the second image.

This structure of the parallax detection device makes it possible to reduce the processing load when performing the dynamic programming method for detecting the parallax. Still further, the parallax detection device according to the exemplary embodiment of the present invention limits the searching region for searching the blocks by using the block matching method. This structure makes it possible to reduce the processing load when the parallax detection device uses the block matching method to detect the parallax. As previously described, the structure of the parallax detection device makes it possible to reduce the processing time and increase the parallax detection accuracy.

### BRIEF DESCRIPTION OF THE DRAWINGS

A preferred, non-limiting embodiment of the present invention will be described by way of example with reference to the accompanying drawings, in which:

FIG. 1 is a block diagram showing a structure of a distance measuring device 1 having an image processing device 4 as a parallax detection device according to an exemplary embodiment of the present invention;

FIG. 2 is a flow chart showing a distance measuring process performed by the image processing device 4 of the distance measuring device 1 shown in FIG. 1;

FIG. 3 is a view showing an example of three types of images G0, G1 and G3 having a different resolution;

FIG. 4 is a flow chart of a first parallax calculation process;

FIG. 5 is a view explaining a method of arranging node points (NP) in a right side image (a reference image) and a left side image (a comparison image);

FIG. 6 is a perspective view showing a node point space (NPS);

FIG. 7 is a perspective view showing a plurality of X-Z planes PL1 to PL3 in the node point space NPS;

FIG. 8 is a perspective view showing a plurality of Y-Z planes PL11 to PL14 in the node point space NPS;

FIG. 9 is a perspective view showing a plurality of right oblique planes PL21 to PL23 in the node point space NPS.

FIG. 10 is a perspective view showing a plurality of left oblique planes PL31 to PL 34 in the node point space NPS;

FIG. 11 is a flow chart of a second parallax calculation process;

FIG. 12 is a view explaining an execution method of a block matching process;

FIG. 13 is a view explaining a fitting matching method; and

FIG. 14 is a view explaining distance measuring results of the distance measuring device 1 having the image processing device 4 according to the exemplary embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Exemplary Embodiment

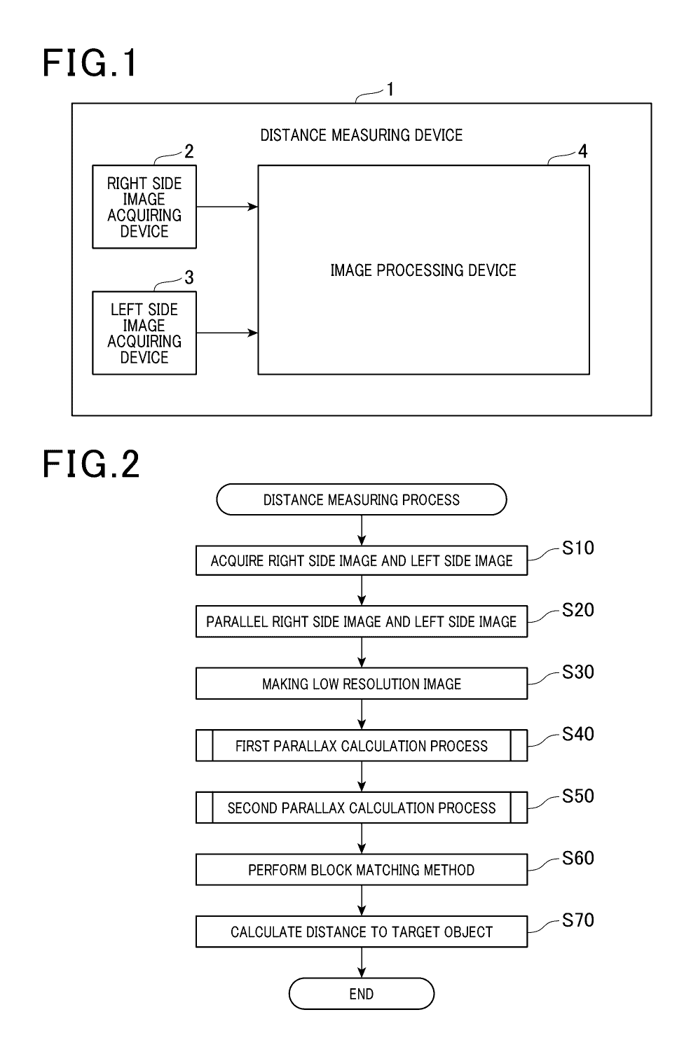

A description will now be given of the distance measuring device 1 having the image processing device 4 according to an exemplary embodiment with reference to FIG. 1 to FIG. 14.

The distance measuring device 1 according to the exemplary embodiment is mounted on a vehicle. As shown in FIG. 1, the distance measuring device 1 has a right side image acquiring device 2, a left side image acquiring device 3, and the image processing device 4. The image processing device 4 corresponds to the parallax detection device.

The right side image acquiring device 2 and the left side image acquiring device 3 successively acquire front-view images, i.e. a front landscape of the vehicle. The right side image acquiring device 2 and the left side image acquiring device 3 transmit the acquired images to the image processing device 4.

The right side image acquiring device 2 is arranged at a right side of the vehicle. The left side image acquiring device 3 is arranged at a left side of the vehicle. Hereinafter, the images acquired by the right side image acquiring device 2 are referred to as the right side images. The images acquired by the left side image acquiring device 3 are referred to as the left side images.

The right side image acquiring device 2 and the left side image acquiring device 3 are arranged to be parallel to each other on the vehicle. Specifically, the right side image acquiring device 2 and the left side image acquiring device 3 are arranged on the vehicle so that an optical axis of the right side image acquiring device 2 and an optical axis of the left side image acquiring device 3 are arranged to be parallel to each other. Further, the right side image acquiring device 2 and the left side image acquiring device 3 are arranged to be separated from to each other by a predetermined base line length along a horizontal direction so that a lateral axis of a surface of the image acquired by the right side image acquiring device 2 and a lateral axis of a surface of the image acquired by the left side image acquiring device 3 are aliened with each other.

In general, a two dimensional orthogonal coordinate system has an X axis and a Y axis, and a surface of acquired image and an optical axis of the image acquiring device cross each other at an origin of the two dimensional orthogonal coordinate system. The lateral axis of the surface of the acquired image is the X axis of the two dimensional orthogonal coordinate system on the surface of the acquired image.

FIG. 1 is a block diagram showing a structure of the distance measuring device 1 having the image processing device 4 as the parallax detection device according to the exemplary embodiment.

In particular, the image processing device 4 is composed of a central processing unit (CPU), a read only memory (ROM), a random access memory (RAM), an input/output (I/O) unit, bus lines, etc. Through the bus lines the CPU, the ROM, the RAM, the I/O unit are connected together. The CPU reads programs stored in the ROM, and executes the programs in order to perform various processes. The CPU, the ROM, the RAM and the I/O unit are omitted from FIG. 1 for brevity.

In the distance measuring device 1 having the structure previously described, the image processing device 4 executes the distance measuring process repeatedly during the operation thereof.

FIG. 2 is a flow chart showing the distance measuring process performed by the image processing device 4 of the distance measuring device 1 shown in FIG. 1.

In step S10 shown in FIG. 2, during the execution of the distance measuring process, the image processing device 4 receives right side images transmitted from the right side image acquiring device 2 and left side images transmitted from the left side image acquiring device 3. The operation flow progresses to step S20.

In step S20, the image processing device 4 corrects a misalignment in the vertical direction between the right side image and the left side image received in step S10 so as to arrange these images parallel to each other. Specifically, the image processing device 4 converts the coordinate in the vertical direction of each of the pixels in the right side image and the left side image according to predetermined correction parameters in order to make a height of each image region (for example, pixels) coincide in the right side image and the left side image corresponding to each other. This process corrects the misalignment in the vertical direction between the right side image and the left side image. The operation flow progresses to step S30.

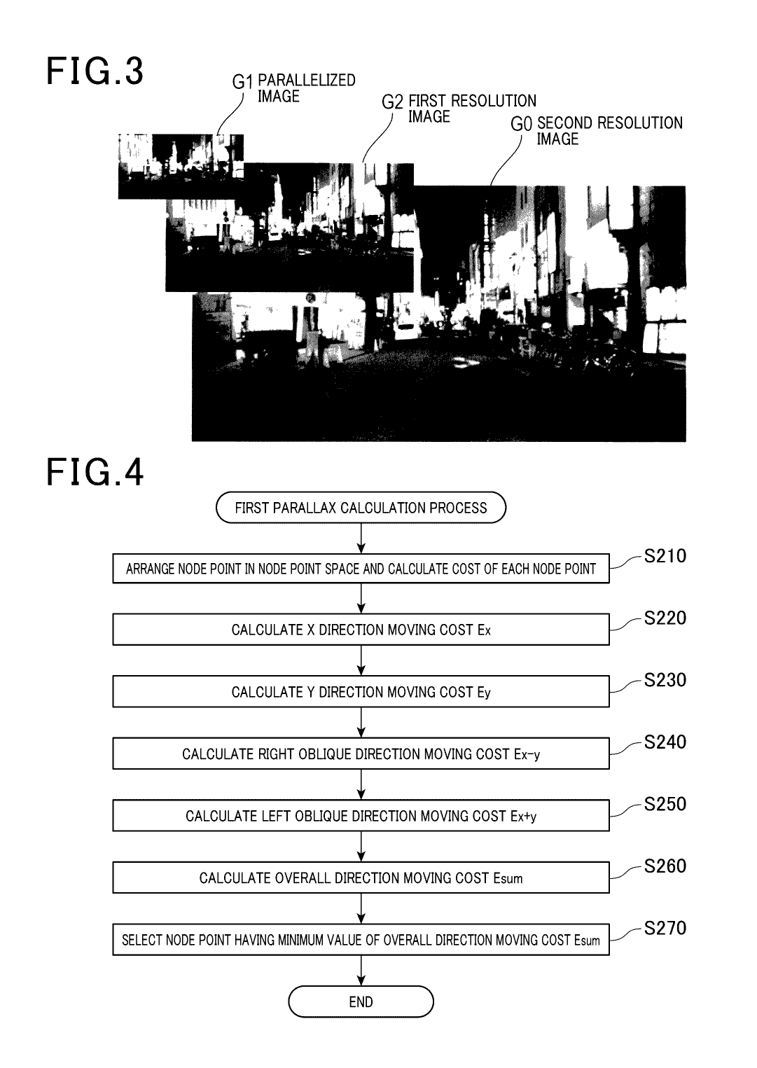

FIG. 3 is a view showing an example of various types of images G0, G1 and G3 having a different resolution.

In step S30, the image processing device 4 makes first resolution images having a predetermined first resolution, and second resolution images having a predetermined second resolution on the basis of the right side image and the left side image (see G0 shown in FIG. 3) which have been corrected to be parallel to each other in step S20.

The first resolution images and the second resolution images are lower in resolution than the right side image and the left side image. That is, the process in step S30, the image processing device 4 provides a first resolution right side image and a first resolution left side image having the predetermined first resolution (which are designated by reference character G1 shown in FIG. 3). The image processing device 4 further provides the second resolution right side image having the predetermined second resolution and the left side image having the predetermined second resolution (which are designated by reference character G2 shown in FIG. 3),

In the following explanation of the exemplary embodiment, the predetermined first resolution is a quarter of the resolution in the vertical direction and lateral direction of the right side image (original image) and the left side image (original image) which have been acquired by the right side image acquiring device 2 and the left side image acquiring device 3, respectively.

Further, the predetermined second resolution is a half of the resolution in the vertical direction and lateral direction of the right side image and the left side image (i.e. the original images) which have been acquired by the right side image acquiring device 2 and the left side image acquiring device 3, respectively. The operation flow progresses to step S40.

A description will now be given of the first parallax calculation process in step S40 shown in FIG. 2 and FIG. 4.

FIG. 4 is a flow chart of a first parallax calculation process to be executed by the image processing device 4. In step S40 shown in FIG. 2, the image processing device 4 executes the first parallax calculation process. FIG. 4 shows the detailed process in step S40 shown in FIG. 2. When the image processing device 4 starts to execute the first parallax calculation process, the image processing device 4 arranges node points NP in a node point space NPS on the basis of the first resolution right side image having the predetermined first resolution, and the first resolution left side image having the predetermined first resolution obtained in step S30. The image processing device 4 calculates a cost of each of the node points NP.

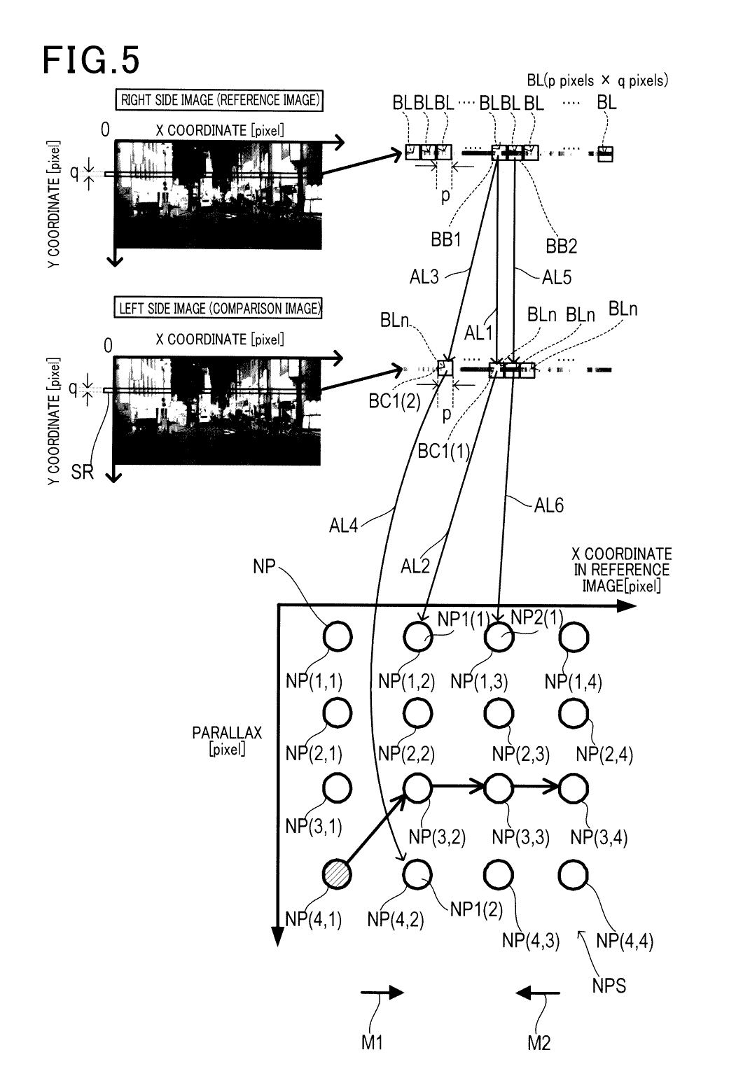

FIG. 5 is a view explaining a method of arranging node points NP in the right side image (as a reference image) and the left side image (as a comparison image). As shown in FIG. 5, the position of each pixel in each of the right side image and the left side image is detected in a physical coordinate system. This physical coordinate system has the origin located at the upper left corner in each of the right side image and the left side image. In the physical coordinate system, the positive direction on the X axis is a rightward direction, and the positive direction on the Y axis is a downward direction. This makes it possible to show the location of each pixel, which forms each image, by using the pixels only. Hereinafter, the position of the pixel on the X direction is referred to as the “X coordinate position”, and the position of the pixel on the Y direction is referred to as the “Y coordinate position”. The right side image is the reference image, and the left side image is the comparison image.

The image processing device 4 divides the reference image having the predetermined first resolution into a plurality of blocks BL, each block BL having a rectangle shape composed of p pixels on the X axis (p is a positive integer) and on the Y axis direction by q pixels (q is a positive integer).

Next, the image processing device 4 detects the searching region SR having the Y coordinate position in the comparison image, where the Y coordinate position is the same as the Y coordinate position of each of the block BL divided in the reference image.

The image processing device 4 extracts the blocks as node setting blocks BLn from the comparison image, each block BLn has a parallax which is different from the parallax of each block BL, and the same size of each block BL (i.e. which has the p pixels in the X axis direction and t pixels in the Y axis direction).

The image processing device 4 arranges the node points NP in the node point space NPS on the basis of the extracted node setting blocks BLn.

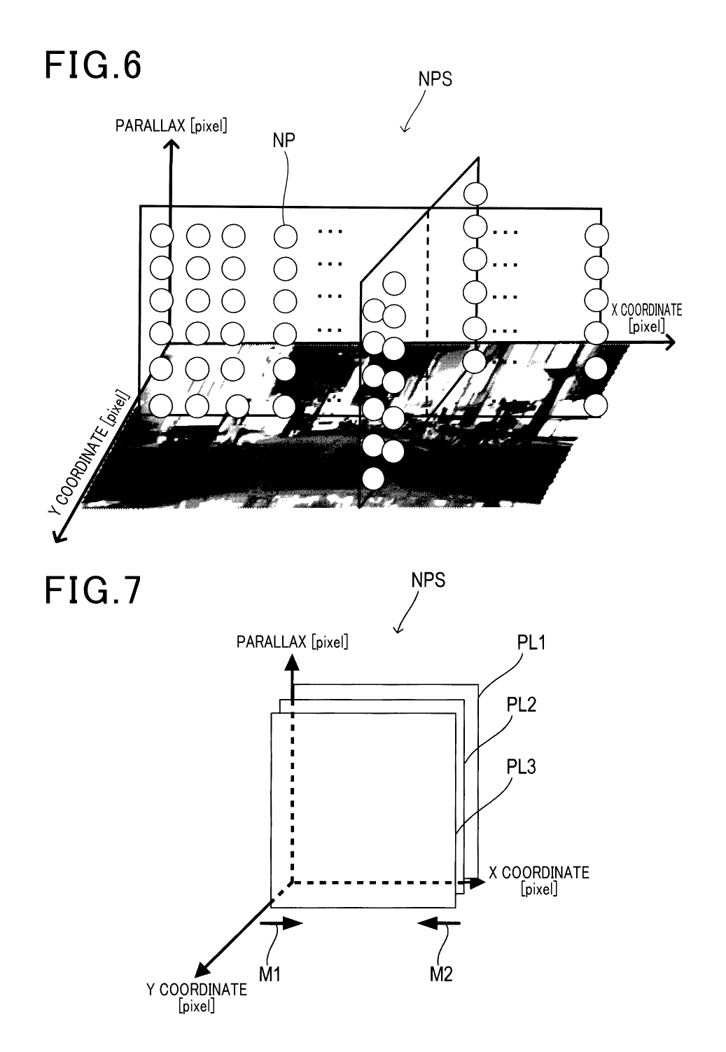

FIG. 6 is a perspective view showing the node point space NPS used by the image processing device 4. As shown in FIG. 6, the node point space NPS is a 3-dimentional orthogonal coordinate space having the X axis, the Y axis and the Z axis. That is, the X coordinate point of the block BL is shown on the X axis, the Y coordinate point of the block BL is shown on the Y axis, and the parallax of the node setting blocks BLn is shown on the X axis.

For example, as shown in FIG. 5, the image processing device 4 extracts, as the node setting block BLn from the comparison image, the block BC1(1) (see the direction designated by the arrow AL1 shown in FIG. 5) having the X coordinate position which is the same as the X coordinate position of the block BB1 in the reference image.

In this case, the node point NP1(1) (see the direction designated by the arrow AL2 shown in FIG. 5), which corresponds to the block BC1(1), is arranged at the coordinate (x1, y1, d1) in the node point space NPS, where x1 indicates the X coordinate position of the block BB1, y1 indicates the Y coordinate position of the block BB1, and d1 indicates a parallax between the block BB1 and the block BC1(1). The node point space NPS indicates the X-Z plane having the Y coordinate y1.

For example, the image processing device 4 extracts, as the node setting block BLn (see the direction designated by the arrow AL3 shown in FIG. 5) from the comparison image, the block BC1(2) having a X coordinate position which is different from the X coordinate position in the searching region SR. In this case, the node point NP1(2), which corresponds to the block BC1(2) in the searching region SR, is arranged at the coordinate (x1, y1, d2) in the node point space NPS (see the direction designated by the arrow AL4 shown in FIG. 5), where d2 indicates a parallax between the block BB1 and the block BC1(2).

Similarly, the image processing device 4 extracts, as the node setting block BLn from the comparison image in the searching region SR, which corresponds to the block BB2 located adjacent to the block BB1 in the reference image.

For example, the image processing device 4 extracts, as the node setting block BLn (see the direction designated by the arrow AL5 shown in FIG. 5), the blocks BC2(1) having the X coordinate point in the searching region SR, which is the same as the X coordinate point of the block BB2 in the reference image.

In this case, the node point NP2(1), which corresponds to the block BC2(1), is arranged at the coordinate (x2, y1, d1) (see the direction designated by the arrow AL6 shown in FIG. 5) in the node point space NPS, where x2 indicates the X coordinate position of the block BB2, y1 indicates the Y coordinate position of the block BL, and d1 indicates a parallax between the block BB2 and the block BC2(1).

The image processing device 4 calculates a cost of each of the nodes NP arranged in the node point space NPS. The cost indicates a degree of similarity between two blocks which have been used to arrange the node points NP in the node point space NPS. The two blocks indicate the block BL in the reference image and the node setting block BLn extracted from the comparison image when the node point NP corresponding to this block BL is arranged. For example, the image processing device 4 calculates the cost of the node point NP1(1) on the basis of the block BB1 and the block BC1(1).

The node position p is composed of the X coordinate position and the Y coordinate position of the node point NP in the node point space NPS, and the parallax of the node point NP is designated by using uₚ.

The cost of the node point NP arranged at the position specified by the node point position p and the parallax uₚ is designated by using D (p, uₚ).

The image processing device 4 calculates the cost D (p, uₚ) on the basis of the known structural similarity SSIM by using the following equation (1).

$$D ( p , {u}_{p} ) = {{{[ \frac{2 {μ}_{x} {μ}_{y} + {c}_{1}}{{μ}_{x}^{2} + {μ}_{y}^{2} + {c}_{1}} ]}^{α} [ \frac{2 {σ}_{x} {σ}_{y} + {c}_{2}}{{σ}_{x}^{2} + {σ}_{y}^{2} + {c}_{2}} ]}^{β} [ \frac{{σ}_{xy} + {c}_{3}}{{σ}_{x} {σ}_{y} + {c}_{3}} ]}^{γ} \qquad ( 1 )$$

where, μₓ indicates an average value of brightness of pixels contained in the block BL in the reference image, μ_{y} indicates an average value of brightness of pixels contained in the node point setting block BLn in the comparison image, σₓ indicates a standard deviation of brightness of pixels contained in the block BL in the reference image, σ_{y} indicates a standard deviation in brightness of the pixels contained in the node point setting blocks BLn in the comparison image, and σ_{xy} indicates a covariance in brightness of the pixels contained in the block BL in the reference image and the node point setting blocks BLn in the comparison image.

The image processing device 4 arranges the node points NP in the node point space NPS for the overall divided blocks BL. After calculating the cost D (p, uₚ) of all node points NP which have been arranged, the image processing device 4 completes the process in step S210. The operation flow progresses to step S220.

In step S220, as shown in FIG. 4, the image processing device 4 calculates the X direction moving cost Ex (which will be explained later in detail) of the node point NP.

As has already been shown in FIG. 5, the block BL is divided along the Y direction into blocks, each having q pixels.

FIG. 7 is a perspective view showing X-Z planes in the node point space NPS. As shown in FIG. 7, a plurality of the X-Z planes, each having the q pixels, are arranged along the Y direction for every q pixel in the node point space NPS. A plurality of the node points NP are arranged in each of the X-Z planes shown in FIG. 7 (see the X-Z planes PL1, PL2, and PL3 shown in FIG. 7.)

The image processing device 4 calculates the X direction moving cost Ex of the node point NP in each of the X-Z planes.

A description will now be given of the method of calculating the X direction moving cost Ex of the node point NP in each of the X-Z planes.

For example, as shown in FIG. 5, a plurality of the node points NP are arranged in a two dimensional array in the X-Z plane. When the Z axis direction is a column direction, and X axis direction is a row direction, the node point NP in i row (i is a positive integer), and j column (j is a positive integer) can be designated by using NP (i, j).

In general, the smaller the parallax, the smaller the value of i, and the more the X coordinate position of the node point NP approaches to the origin, the more the value of j becomes a small value.

The image processing device 4 selects, as the end point, one of the node points NP arranged on the X-Z plane. The image processing device 4 selects, as the start point, the node point NP which is close to the origin in the X-Z plane. For example, the image processing device 4 selects as the start point, the node point NP arranged on i-th row and first column in the X-Z plane.

The image processing device 4 moves the node point NP from the start point along the X direction by one, i.e. the node point NP is moved to the node point arranged at the second column along the X direction designated by the arrow M1 shown in FIG. 5 and FIG. 7.

Further, the image processing device 4 moves the node point NP on the second column along the X direction by one, i.e. to the node point arranged at the third column.

The image processing device 4 repeats the moving of the node point NP, i.e. sequentially moves the node point NP along the X direction by one until the node point NP reaches the end point. The moving path along the positive X direction of the node point NP is referred to as the rightward direction moving path. FIG. 5 shows the rightward direction moving path composed of the node NP(4,1), NP (3, 2), NP (3, 3), and NP (3, 4) arranged in the rightward direction.

The image processing device 4 calculates the cost E of the detected moving path by using the following equation (2).

$$\begin{matrix}E = {\sum }_{p} D ( p , {u}_{p} ) + {\sum }_{p , q ∈ ɛ} S ( {u}_{p} , {u}_{q} ) \\ = {\sum }_{p} D ( p , {u}_{p} ) + {\sum }_{p , q ∈ ɛ} \vert {u}_{p} - {u}_{q} \vert\end{matrix} \qquad ( 2 )$$

where the first term in the equation (2) is a data term which indicates the sum of the cost D (p, uₚ) of the node points NP arranged on the moving path. The second term in the equation (2) is a regularization term. In the equation (2), the second term S (uₚ, u_{q}) indicates a parallax term when the node Np having the parallax uₚ is moved to the node point NP having the parallax u_{q}.

The second term S (uₚ, u_{q}) is a function value which increases when increasing a difference between the parallax uₚ and the parallax u_{q}.

In the exemplary embodiment, the second term S (uₚ, u_{q}) is an absolute value of the difference between the parallax uₚ and the parallax u_{q}. Accordingly, the second term in the equation (2) indicates the total sum in change of the parallax when the node point is moved along the rightward direction moving path.

The process previously described makes it possible to determine all of the possible rightward direction moving paths when the start point is selected from one of the node points arranged on the first column and the end point is selected from the plurality of the node points NP, and to calculate the cost E of each of the overall possible moving paths. The image processing device 4 calculates the moving path having the minimum cost E.

The image processing device 4 according to the exemplary embodiment calculates and specifies the moving path having the minimum cost E by using the known Viterbi algorithm as a kind of the dynamic programming method instead of calculating the cost E of each of the overall possible moving paths.

In step S220, the image processing device 4 specifies the rightward direction moving path having the minimum cost E from the overall node points NP arranged in the X-Z plane. This calculates the minimum cost (hereinafter, the rightward direction moving cost) in the rightward direction moving path in each of all of the node points NP arranged on the X-Z plane.

Next, like the method of calculating the rightward direction moving cost previously described, the image processing device 4 calculates the minimum cost (hereinafter, the leftward direction moving cost) of the leftward direction moving path on the X-Z plane composed of the overall node points NP.

Specifically, the image processing device 4 selects, as the end point, one from the plurality of the node points NP arranged on the X-Z plane. The image processing device 4 selects, as the start point, one selected from the node points NP (i.e. the node point NP arranged at the final column in the row i), which is farthest on the X coordinate in the X-Z plane from the origin on the X-Z plane. The image processing device 4 moves the node point NP by one, i.e. to one of the node points arranged at the adjacent column in the negative direction of the X axis from the start point by one (see the direction M2 shown in FIG. 5 and FIG. 7).

Further, the image processing device 4 moves the current node point NP to the node point NP arranged at the adjacent column. The image processing device 4 sequentially moves the current node point NP from the start point in the negative direction on the X axis by one column to the end point NP through a single moving path. Hereinafter, this moving path is referred to as the leftward direction moving path. The operation flow progresses to step S220.

In step S220, like the case of the rightward direction moving path previously described, the image processing device 4 specifies the leftward direction moving path having the minimum cost E in the overall node points NP arranged in the X-Z plane. The image processing device 4 calculates the leftward direction moving path having the minimum cost (hereinafter, the leftward direction moving cost) in the overall node points NP in the X-Z plane.

In step S220, the image processing device 4 adds the rightward direction moving cost and the leftward direction moving cost in the overall node points NP arranged on the X-Z plane to obtain the X direction moving cost Eₓ.

After calculating the X direction moving cost Ex in the X-Z plane, the image processing device 4 calculates the X direction moving cost Ex in the next X-Z plane. After calculation of the X direction moving cost Ex in the overall X-Z plane, the image processing device 4 completes the process in step S220. The operation flow progresses to step S230.

In step S230, as shown in FIG. 4, the image processing device 4 calculates the Y direction moving cost Ey (which will be explained later in detail) of the node points NP. The block BL has been divided for every p pixel along the X direction (see FIG. 5).

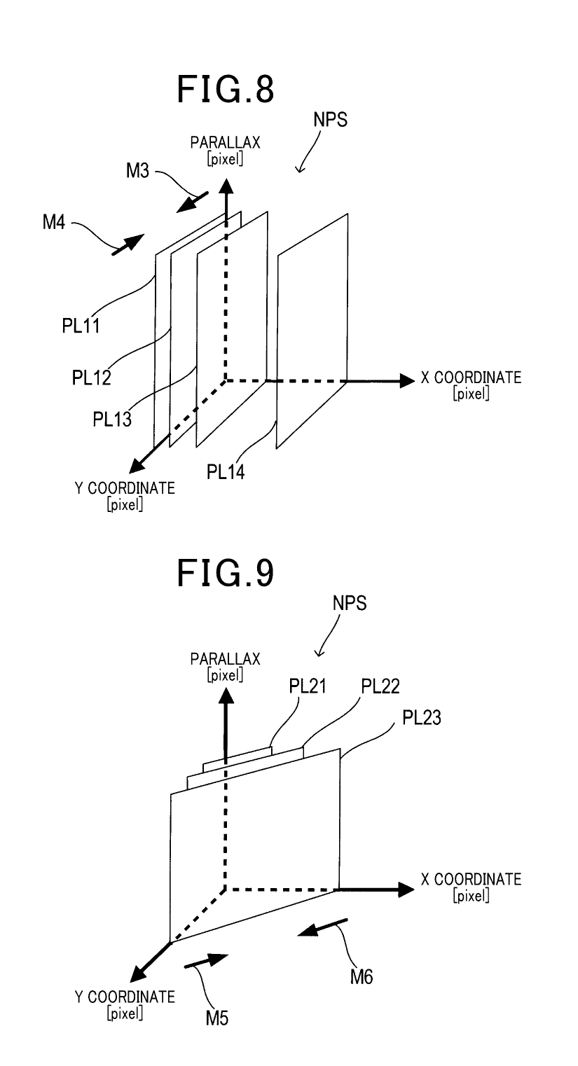

FIG. 8 is a perspective view showing a plurality of Y-Z planes PL11 to PL13 in the node point space NPS. As shown in FIG. 8, the plurality of the Y-Z planes, in each of which the plurality of the node points NP are arranged, are present for every p pixel along the X axis direction in the node point planes NP (for example, see the Y-Z planes PL11, PL12, PL13 and Pl14).

In step S230, the image processing device 4 calculates the Y direction moving cost Ey of the node point NP in each of the plurality of the Y-Z planes. The image processing device 4 uses the Y-Z planes in order to calculate the Y direction moving cost Ey of the node points NP, instead of using the X-Z planes for calculating the X direction moving cost previously described.

Specifically, the image processing device 4 selects, as the start point, one selected from the node points NP, i.e. the Y coordinate of which is nearest to the origin of the Y-Z plane. The image processing device 4 sequentially moves the node point NP in the forward direction of the Y axis by one column (see the direction designated by the arrow M3 shown in FIG. 8) until reaching the node point NP as the end point. This moving path is referred to as the downward moving path.

Further, the image processing device 4 selects, as the start point, one from the node points NP, i.e. the Y coordinate of which is farthest from the origin of the Y-Z plane. The image processing device 4 sequentially moves the node point NP in the negative direction of the Y axis by one column (see the direction designated by the arrow M4 shown in FIG. 8) until the node point NP as the end point. This moving path is referred to as the upward moving path.

In step S230, the image processing device 4 specifies the downward moving path having the minimum cost E and the upward moving path having the minimum cost in the overall node points NP arranged on the Y-Z plane. This process makes it possible to calculate the minimum cost in the downward moving path (hereinafter, referred to as the downward moving cost) and the minimum cost in the upward moving path (hereinafter, referred to as the upward moving cost).

In step S230, the image processing device 4 further calculates, as a Y direction moving cost E_{y}, an addition of the downward moving cost and the upward moving cost in the overall node points NP arranged on the Y-Z planes.

After calculation of the Y direction moving cost E_{y} in this Y-Z plane, the image processing device 4 calculates the Y direction moving cost E_{y}, in next Y-Z plane by the same procedure previously described. After calculation of the Y direction moving cost E_{y} for the overall Y-Z planes, the image processing device 4 completes the process in step S230. The operation flow progresses to step S240.

In step S240, as shown in FIG. 4, the image processing device 4 calculates a right oblique direction moving cost Ex−y (which will be explained later).

FIG. 9 is a perspective view showing a plurality of right oblique planes PL21 to PL23 in the node point space NPS.

In step S240, as shown in FIG. 9, the image processing device 4 detects a plurality of the planes, for example, the planes PL21 to PL23 which are arranged perpendicular to the X-Y plane between the X axis and Y axis in the node point space NPS. The planes PL21 to PL23 are referred to as the right oblique planes PL21 to PL23 shown in FIG. 9. These right oblique planes PL21 to PL23 are arranged to be parallel to each other, and the node points NP are arranged on the overall surface of each of the right oblique planes PL21 to PL23.

In step S240, the image processing device 4 calculates a right oblique direction moving cost Ex−y of the node points NP arranged on each of the right oblique planes PL21 to PL23. The procedure of calculating the right oblique upward direction moving cost Ex−y of the node points NP is the same as the procedure of calculating the X direction moving cost Ex of the node points NP other than using the right oblique planes instead of the X-Z planes.

Specifically, the image processing device 4 selects, as the start point, one selected from the node points NP, i.e. which is nearest to the Y axis. The image processing device 4 moves the node point NP to the X axis by one column (see the direction designated by the arrow M5 shown in FIG. 9) until the node point NP as the end point. This moving path is referred to as the right upward moving path.

Further, the image processing device 4 selects, as the start point, one from the node points NP, i.e. which is farthest from the X axis. The image processing device 4 moves the node point NP to the Y axis by one column (see the direction designated by the arrow M6 shown in FIG. 9) until the node point NP as the end point. This moving path is referred to as the left downward moving path.

In step S240, the image processing device 4 specifies the right upward moving path having the minimum cost E and the left downward moving path having the minimum cost in the overall node points NP arranged on the right oblique plane. This process makes it possible to calculate the minimum cost in the right upward moving path (hereinafter, referred to as the right upward moving path cost) and the minimum cost in the left downward moving path (hereinafter, referred to as the left downward moving path cost).

In step S240, the image processing device 4 further calculates, as a right oblique direction moving cost E_{x-y}, an addition of the right upward moving cost and the left downward moving cost in the overall node points NP arranged on these right oblique planes.

After calculation of the right oblique direction moving cost E_{x-y} in this right oblique plane, the image processing device 4 calculates the right oblique direction moving cost E_{x-y}, in next right oblique plane by the same procedure previously described. After calculation of the right oblique direction moving cost E_{x-y} for the overall right oblique planes, the image processing device 4 completes the process in step S240. The operation flow progresses to step S250.

In step S250, as shown in FIG. 4, the image processing device 4 calculates a left oblique direction moving cost Ex+y (which will be explained later).

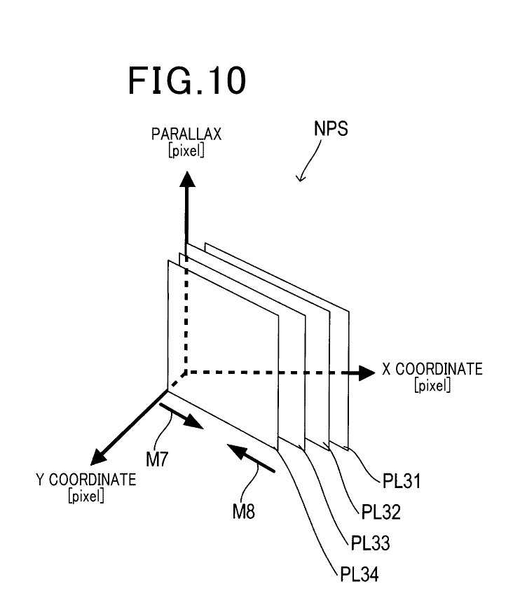

FIG. 10 is a perspective view showing a plurality of left oblique planes PL31 to PL 34 in the node point space NPS.

In step S250, as shown in FIG. 10, the image processing device 4 detects a plurality of the planes, for example the planes PL31 to PL34 which are intersect with the right oblique plane in the node point space NPS. The planes PL31, PL32, PL33 and PL34 are referred to as the left oblique planes PL31, PL32, PL33 and PL34 shown in FIG. 10. These left oblique planes PL31 to PL34 are arranged to be parallel to each other, and the node points NP are arranged on the overall surface of each of the left oblique planes PL31 to PL34.

In step S250, the image processing device 4 calculates a left oblique direction moving cost Ex+y of the node points NP arranged on each of the left oblique planes PL31 to PL34. The calculation of the left oblique upward direction moving cost Ex+y is basically equal to the calculation of the X direction moving cost Ex of the node points NP previously described, but is different from the use of the left oblique planes.

Specifically, the image processing device 4 selects, as the start point, one selected from the node points NP, i.e. which is nearest to the origin. The image processing device 4 moves the node point NP toward the direction apart from the origin, by one column (see the direction designated by the arrow M7 shown in FIG. 10) until the node point NP reaches the end point. This moving path is referred to as the right downward moving path.

Further, the image processing device 4 selects, as the start point, one from the node points NP, i.e. which is farthest from the origin. The image processing device 4 moves the node point NP toward the direction to approach the origin by one column (see the direction designated by the arrow M8 shown in FIG. 10) until the node point NP as the end point. This moving path is referred to as the left upward moving path.

In step S250, the image processing device 4 specifies the right downward moving path having the minimum cost E, and the left upward moving path having the minimum cost E in the overall node points NP arranged on the left oblique plane. This process makes it possible to calculate the minimum cost of the right downward moving path (hereinafter, referred to as the right downward moving path cost) and the minimum cost of the left upward moving path (hereinafter, referred to as the left upward moving path cost).

Further, in step S250, the image processing device 4 adds the right downward moving cost and the left upward moving cost together in the overall node points NP arranged on these left oblique planes, and detects the addition result as a left oblique direction moving cost E_{x+y}.

After calculation of the left oblique direction moving cost E_{x+y} in the left oblique plane, the image processing device 4 calculates the left oblique direction moving cost E_{x+y}, in a next left oblique plane by the same procedure previously described. After calculation of the left oblique direction moving cost E_{x+y} for the overall left oblique planes, the image processing device 4 completes the process in step S250. The operation flow progresses to step S260.

In step S260, as shown in FIG. 4, the image processing device 4 calculates an overall direction moving cost Eₛᵤₘ for overall node points in the node point space NPS by using the following equation (3).

Eₛᵤₘ=Eₓ+E_{y}+E_{x-y}+E_{x+y} (3)

The operation flow progresses to step S270.

In step S270, the image processing device 4 selects the node point NP having the minimum overall direction moving cost Eₛᵤₘ from the plurality of the node points NP having a different parallax, the same X coordinate position and the same Y coordinate position in each of the blocks BL which form the reference image. The image processing device 4 completes the first parallax calculation process in step S40 shown in FIG. 2 and FIG. 4.

After the completion of the first parallax calculation process in step S40 shown in FIG. 2, the image processing device 4 executes the second parallax calculation process in step S50 shown in FIG. 2.

A description will now be given of the second parallax calculation process in step S50 shown in FIG. 2.

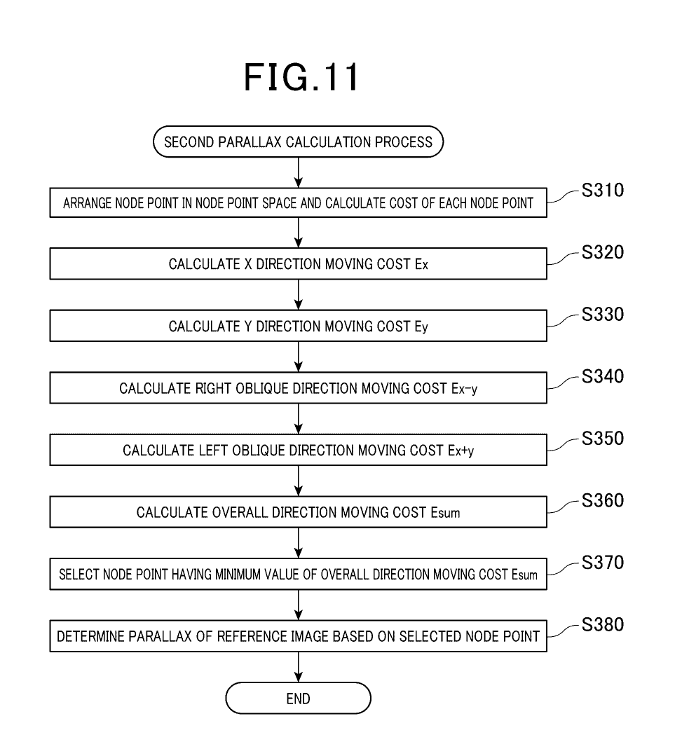

FIG. 11 is a flow chart of the second parallax calculation process. As shown in FIG. 11, the image processing device 4 detects and arranges the node points NP in the node point space NPS by using the right side image (as the reference image) having the second resolution and the left side image (as the comparison image) generated in step S30. The image processing device 4 further calculates the cost of each node point NP.

Because the second parallax calculation process in step S50 shown in FIG. 2 performs the same process in step S210 of arranging each node point NP in the node point space NPS and calculating the cost of each node point NP, the explanation of the same process is omitted here for brevity.

After the process in step S310, the operation flow progresses to step S320. In step S320, the image processing device 4 calculates the X direction moving cost Ex of the node point NP. In the process in step S320, the image processing device 4 calculates the X direction moving cost Ex of each of the node points NP which are located near the node point NP selected in step S270, but does not calculate the X direction moving cost Ex of the overall node points NP in the node point space NPS.

In step S320, because the image processing device 4 calculates the X direction moving cost Ex of the node point NP by using the same method shown in step S220, the explanation thereof is omitted here. After the process in step S320, the operation flow progresses to step S330.

In step S330, the image processing device 4 calculates the Y direction moving cost Ey of the node point NP. In the process of step S330, the image processing device 4 calculates the Y direction moving cost Ey of each of the node points NP which are located near the node point NP selected in step S270, not calculate the Y direction moving cost Ey of the overall node points NP arranged in the node point space NPS.

In step S330, because the image processing device 4 uses the same calculation method shown in step S230 to calculate the Y direction moving cost Ey of the node point NP, the explanation thereof is omitted here. After the process in step S330, the operation flow progresses to step S340.

In step S340, the image processing device 4 calculates the right oblique direction moving cost Ex−y of the node point NP. In the process in step S340, the image processing device 4 calculates the right oblique direction moving cost Ex−y of each of the node points NP which are located near the node point NP selected in step S270, not calculate the right oblique direction moving cost Ex−y of the overall node points NP.

In step S340, because the image processing device 4 uses the same calculation method shown in step S240 to calculate the right oblique direction moving cost Ex−y of the node point NP, the explanation thereof is omitted here. After the process in step S340, the operation flow progresses to step S350.

In step S350, the image processing device 4 calculates the left oblique direction moving cost Ex+y of the node point NP. In the process in step S350, the image processing device 4 calculates the left oblique direction moving cost Ex+y of each of the node points NP which are located near the node point NP selected in step S270, not calculate the left oblique direction moving cost Ex+y of the overall node points NP.

In step S350, because the image processing device 4 uses the same calculation method shown in step S250 to calculate the left oblique direction moving cost Ex+y of the node point NP, the explanation thereof is omitted here. The operation flow progresses to step S350. After the process in step S350, the operation flow progresses to step S360.

In step S360, the image processing device 4 calculates the overall direction moving cost Eₛᵤₘ by using the same method in step S260. The operation flow progresses to step S370.

In step S370, the image processing device 4 selects the node point NP having the minimum overall direction moving cost Eₛᵤₘ from the plurality of the node points NP having a different parallax in each of the blocks BL which form the reference image. The operation flow progresses to step S380.

In step S380, the image processing device 4 detects the parallax of the node point NP selected in step S370 as the parallax of the corresponding block BL. After the process in step S380, i.e. determining the parallax of each of the overall blocks BL forming the reference image, the image processing device 4 completes the execution of the second parallax calculation process. The operation flow progresses to step S60 shown in FIG. 2.

Next, the image processing device 4 executes a block matching process in step S60 shown in FIG. 2 by using the right side image and the left side image (i.e. the original images as the reference images) which have been corrected to be parallel to each other in step S20

In step S60, the image processing device 4 uses the right side image and the left side image, which have been parallel to each other, as the reference image and the comparison image, respectively. The image processing device 4 divides the reference image, i.e. the right side image into the blocks BLm, each block BL having a rectangle shape composed of (2m+1) pixels (m is a positive integer) in the X axis and (2n+1) pixels (n is a positive integer) in the Y axis.

In step S60, the image processing device 4 detects a corresponding point searching region in each of the divided blocks BLm.

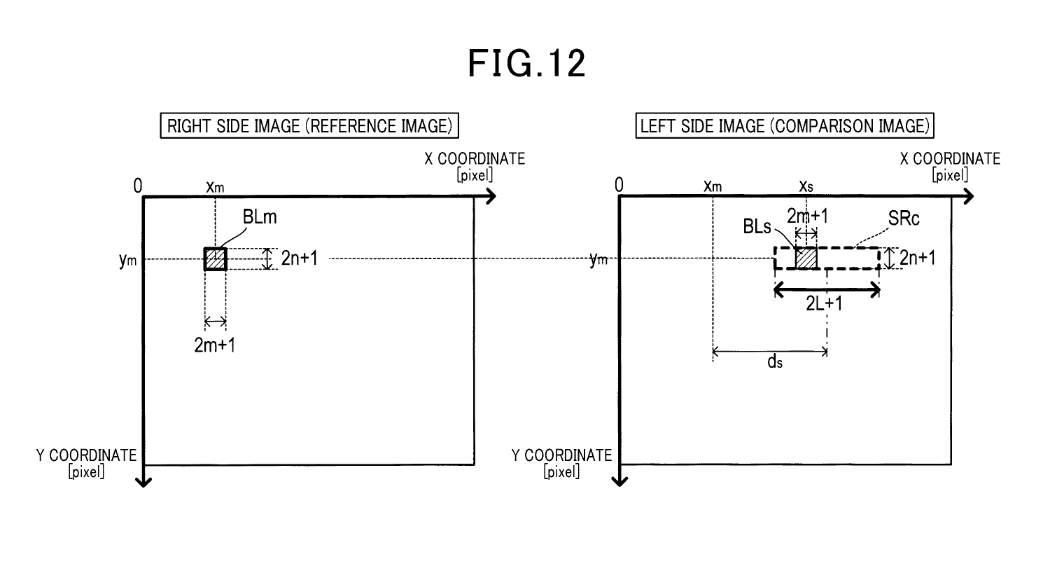

FIG. 12 is a view explaining the method of executing the block matching process. As shown in FIG. 12, a block BLm in the reference image is designated by the coordinate (xₘ, yₘ). That is, the coordinate (xₘ, yₘ) of the block BLm corresponds to the position of the pixel located at the central point of the block BLm.

The image processing device 4 detects the parallax of the block BLm on the basis of the result in step S380. Specifically, the image processing device 4 selects the block BL containing the coordinate (xₘ, yₘ) of the block BLm in the right side image having the second resolution, and detects the parallax of the specified block BL as the parallax of the block BLm.

Next, the image processing device 4 detects the searching region SRc in the comparison image on the basis of the parallax and coordinate of the block BLm in the reference image.

The X direction range of the searching region SRc is designated from (xₘ+dₛ−2L) to (xₘ+dₛ+2L), and the Y direction range of the searching region SRc is designated from (yₘ−2n) to (yₘ+2n), where dₛ [pixies] indicates the parallax of the block BLm and (2L+1) [pixels] indicates the X direction length of the searching region SRc.

The image processing device 4 moves, in the searching region SRc, the searching block BLs having the size which is the same as the size of the block BLm, where the searching block ZBLs has a rectangular shape having m pixels in the X axis direction and n pixels in the Y axis direction. The image processing device 4 moves the searching blocks BLs in the searching region SRc, and executes the known SAD (Sum of Absolute Difference) method by using the pixels contained in each of the searching blocks BLs and the pixels contained in the blocks BLm in the reference image.

When the block BLm is located at the coordinate (xₘ, yₘ), and the X coordinate position of the searching block BLs is Xₛ, the image processing device 4 obtains an evaluation value M (xₘ, yₘ, xₛ) by using the SAD. The obtained evaluation value M (xₘ, yₘ, xₛ) is designated by using the following equation (4).

$$M ( {x}_{m} , {y}_{m} , {x}_{s} ) = {\sum }_{i = - m}^{m} {\sum }_{j = - n}^{n} \vert {I}_{m} ( {x}_{m} + i , {y}_{m} + j ) - {I}_{s} ( {x}_{s} + i , {y}_{m} + j ) \vert \qquad ( 4 )$$

where Is indicates brightness of each pixel contained in the searching block BLs.

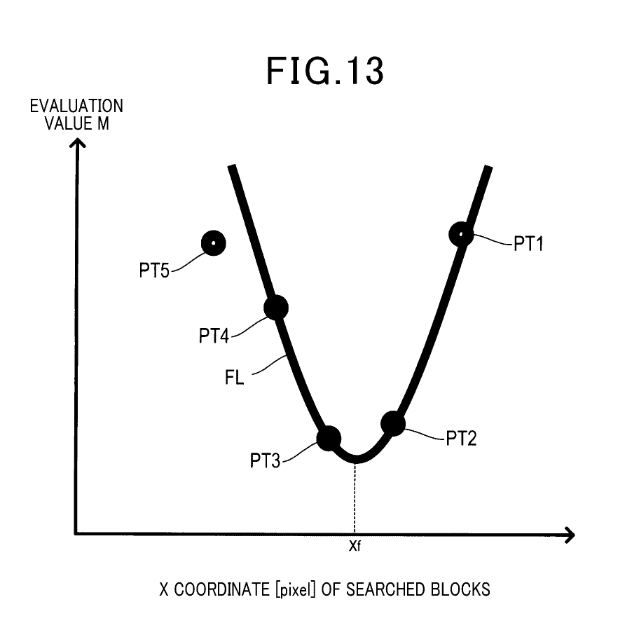

FIG. 13 is a view explaining a fitting matching method. As shown in FIG. 13, the graph is made by using a plurality of calculated evaluation values M (xₘ, yₘ, xₛ), i.e. the plot points PT1, PT2, PT3, PT4 and PT5. The fitting of the plot points PT1, PT2, PT3, PT4 and PT5 is performed by using a fitting function such as a quadratic function. The image processing device 4 calculates the X coordinate position xf having a minimum value of a fitting curve (see the curve FL shown in FIG. 13) obtained by the fitting function. That is, a difference between the X coordinate position Xf and the X coordinate position xₘ of the block BLm indicates the parallax of the block BLm.

After the parallax of one block BLm, the image processing device 4 repeatedly executes the parallax calculation for a next block BLm. When completing the parallax calculation for the overall blocks BLm, the image processing device 4 completes the process in step S60.

After the process in step S60 shown in FIG. 2, the operation flow progresses to step S70.

In step S70, the image processing device 4 calculates a distance to the target object by using the known distance calculation equation using the parallax data on the basis of the parallax of the overall blocks BLm calculated in step S60, the image processing device 4 completes the distance measuring process. This makes it possible to specify the distance to the object in each block BLm forming the reference image.

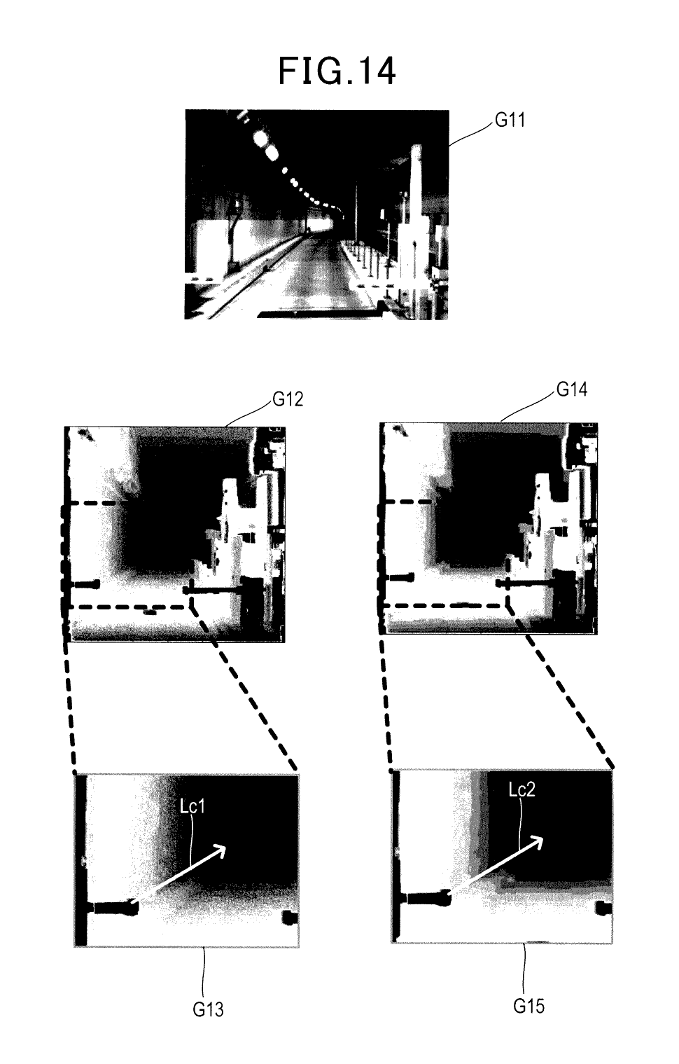

FIG. 14 is a view showing the distance measuring results of the distance measuring device 1 having the image processing device 4 according to the exemplary embodiment. Further, FIG. 14 shows the distance measuring results (hereinafter, comparison measuring results) obtained on the basis of the calculated overall direction moving cost Eₛᵤₘ instead of performing the block matching in step S60, like the processes in step 40 and step S50.

The distance measuring device 1 having the image processing device 4 according to the exemplary embodiment provides the distance measuring results which are obtained by the dynamic programming method using the image having the first resolution and the image having the second resolution, and performing the block matching of the original images, where the original images have been captured by the right side image acquiring device 2 and the left side image acquiring device 3 mounted on the vehicle.

The comparison measuring results are obtained by performing the dynamic programming method using the image having the first resolution, the image having the second resolution, and the captured original images.

The image G11 shown in FIG. 14 indicates the image acquired by the right side image acquiring device 2. The image G12 shown in FIG. 14 indicates the distance measuring result obtained by the distance measuring device 1 having the image processing device 4 according to the exemplary embodiment using the image G11. The image G13 shown in FIG. 14 is an enlarged view of a part of the image G12. The image G14 shown in FIG. 14 indicates the comparison measuring result using the image G11. The image G15 shown in FIG. 14 is an enlarged view of a part of the image G14.

As can be clearly understood from the comparison result of the image G13 with the image G15 shown in FIG. 14, in the sequentially-changed distance part in the image G11, the shade of the distance measuring results is continuous changed in the image G13, but the shade of the distance measuring results is discontinuous changed in the image G15 (see the arrow Lc1 in the image G13 and the arrow Lc2 in the image G15).

The image processing device 4 in the distance measuring device 1 according to the exemplary embodiment having the structure previously described obtains the right side image and the left side image acquired simultaneously by using the right side image acquiring device 2 and the left side image acquiring device 3 having a different viewpoint (step S10).

The image processing device 4 in the distance measuring device 1 makes the right side images and the left side images having the predetermined first resolution and the predetermined second resolution (i.e. the low resolution right side images and the low resolution left side images) on the basis of the right side image and the left side image acquired by the image acquiring devices 2 and 3 so that the predetermined first resolution and the predetermined second resolution are lower than the resolution of the right side image and the left side image acquired by the image acquiring devices (step S30).

The distance measuring device 1 according to the exemplary embodiment divides the low resolution right side image into a plurality of the blocks BL composed of a plurality of pixels.

Further, the distance measuring device 1 having the image processing device 4 according to the exemplary embodiment detects the parallax of each block BL by the dynamic programming method of searching the node point setting block BLn having the region which is the same as the region of the block BL for every divided block BL in the low resolution left side image (step S210 to S270, and steps S310 to S370).

The distance measuring device 1 having the image processing device 4 according to the exemplary embodiment divides the right side image acquired by the right side image acquiring device 2 into a plurality of the blocks BLm. The distance measuring device 1 detects the parallax of the block BLm by performing the block matching method to determine the block (hereinafter, referred to as the image resolution corresponding block) having the region which is the same as the region of the block BLm in the left side image for every divided block BLm (step S60).

Further, the distance measuring device 1 detects the searching region (step S60) by searching the image resolution corresponding block by using the block matching method in the right side image on the basis of the parallax detection results (steps S40 and S50) by using the dynamic programming method.

As previously described in detail, the distance measuring device 1 uses the block matching method to detect the parallax of the block in addition to using the dynamic programming method. The distance measuring device 1 having the structure previously described can avoid obtaining discontinuous parallax detection results caused by the target function containing the regularization terms in the dynamic programming method. This makes it possible to increase the parallax detection accuracy. Further, because of processing the right side image and left side image having the low resolution by performing the dynamic programming method, the distance measuring device 1 can reduce the processing load to detect the parallax. Still further, because the distance measuring device 1 limits the searching region to search the blocks by using the block matching method, it is possible to reduce the processing load to detect the parallax on the basis of the block matching method. As previously described, the distance measuring device 1 having the image processing device 4 according to the exemplary embodiment can reduce the processing period of time to increase the parallax detection accuracy simultaneously.

Further, the distance measuring device 1 arranges the node points NP in the node point space NPS. Each of these node points NP is specified on the basis of the two dimensional position and the parallax of the block BL in the low resolution right side image for every block BL. The node point space NPS is a three dimensional space determined by the two dimensional position of each block BL and the parallax of the block BL (steps S210 and S310).

Further, the distance measuring device 1 having the image processing device 4 calculates the cost D (p, uₚ) which is reduced when increasing the similarity between the block BL corresponding to the node point NP and the node point setting block BLn in the left side image having the low resolution which is separated from the block BL by the parallax of the corresponding node point NP (steps S210 and S310).

Further, the distance measuring device 1 having the image processing device 4 calculates the parallax cost S (uₚ, u_{q}) which increases when increasing the difference in parallax between the first node point and the second node point when the node point NP is moved to another node point NP in the node point space NPS (steps S220 to S250, and steps S320 to S350).

In addition, the distance measuring device 1 having the image processing device 4 selects the node points as the end point and the first start point, respectively, from the node points NP arranged in the node point space NP. The first start point is located at one end position of the node point space NPS. The distance measuring device 1 having the image processing device 4 detects the rightward direction moving path, the downward moving path, the right oblique moving path and the right downward moving path, each of which is from the start point to the end point (steps S220 to S250, the steps S320 to S350).

Hereinafter, the group composed of the rightward direction moving path, the downward moving path, the right oblique moving path and the right downward moving path is referred to as the first moving path.

Still further, the distance measuring device 1 having the image processing device 4 selects the node point as the second start point from the node points NP arranged in the node point space NP. The second start point is located at the other end point opposite to the one end point in the node point space NPS. The distance measuring device 1 having the image processing device 4 detects the leftward direction moving path, the upward moving path, the left oblique moving path and the left downward moving path, each of which is from the second start point to the other end point (steps S220 to S250, the steps S320 to S350).

Hereinafter, the group composed of the leftward direction moving path, the upward moving path, the left oblique moving path and the left downward moving path is referred to as the second moving path.

Further, the distance measuring device 1 having the image processing device 4 detects the total sum of the cost D (p, uₚ) of the node point NP arranged on the first moving path and the parallax cost S (uₚ, u_{q}) of the first moving path as the rightward direction moving cost, the downward moving cost, the right upward moving cost, and the right downward moving cost (steps S220 to S250, and the steps S320 to S350). Hereinafter, the group of the rightward direction moving cost, the downward moving cost, the right upward moving cost, and left downward moving cost is referred to as the first moving cost.

Still further, the distance measuring device 1 having the image processing device 4 detects the total sum of the cost D (p, uₚ) of the node points NP arranged on the second moving path and the parallax cost S (uₚ, u_{q}) of the second moving path as the leftward direction moving cost, the upward moving cost, the left downward moving cost, and the left upward moving cost (steps S220 to S250, and the steps S320 to S350). Hereinafter, the group of the leftward direction moving cost, the upward moving cost, the left downward moving cost, and the left upward moving cost is referred to as the second moving cost.

The distance measuring device 1 having the image processing device 4 searches the first moving path having the first minimum moving cost (hereinafter, referred to as the first minimum moving path) and the second moving path having the second minimum moving cost (hereinafter, referred to as the second minimum moving cost) by using the dynamic programming method (steps S220 to S250, and the steps S320 to S350).

The distance measuring device 1 having the image processing device 4 calculates the X direction moving cost Eₓ, the Y direction moving cost E_{y}, the right oblique direction moving cost E_{x-y}, and the left oblique direction moving cost E_{x+y}, on the basis of the first minimum moving cost and the second minimum moving cost (steps S220 to S250, and steps S320 to S350).

The distance measuring device 1 having the image processing device 4 detects, as the parallax of the block BL, the parallax of the node point NP having the minimum total direction moving cost Eₛᵤₘ in the node points corresponding to the block BL for every block BL (steps S260, S270, S360 and S370).

As previously described, the distance measuring device 1 having the image processing device 4 detects the parallax by using the dynamic programming method which uses, as the target function, the moving cost containing the parallax cost S (uₚ, u_{q}) as the regularization term. Further, the distance measuring device 1 having the image processing device 4 detects the parallax by using the block matching method finally. This makes it possible for the distance measuring device 1 to avoid obtaining discontinuous parallax detection results. This makes it possible to increase the parallax detection accuracy

The distance measuring device 1 having the image processing device 4 calculates the X direction moving cost Eₓ, the Y direction moving cost E_{y}, the right oblique direction moving cost E_{x-y} and the left oblique direction moving cost E_{x+y} in different directions, i.e. in the X direction, the Y direction, the right oblique direction, and the left oblique direction, respectively (steps S260, S270, S360 and S370).

The distance measuring device 1 having the image processing device 4 detects the parallax of the block BL on the basis of the calculated costs, i.e. the X direction moving cost Eₓ, the Y direction moving cost E_{y}, the right oblique direction moving cost E_{x-y} and the left oblique direction moving cost E_{x+y} (steps S260, S270, S360 and S370).

As previously described in detail, the distance measuring device 1 having the image processing device 4 detects the parallax on the basis of the moving costs calculated in a plurality of the different moving directions, it is possible to reduce the influence of noise, to the parallax detection results, where the noise is contained in the right side image and the left side image acquired by the right side image acquiring device 2 and the left side image acquiring device 3. The structure and behavior of the distance measuring device 1 having the image processing device 4 makes it possible to increase the parallax detection accuracy.

The distance measuring device 1 having the image processing device 4 makes the first resolution right side image having the predetermined first resolution, the first resolution left side image having the predetermined first resolution, the second resolution right side image having the predetermined second resolution, and the second resolution left side image having the predetermined second resolution. The predetermined first resolution is different from the predetermined second resolution. Each of the predetermined first resolution and the predetermined second resolution is lower than the resolution of the right side image and the left side image acquired by the right side image acquiring device 2 and the left side image acquiring device 3 (step S30).

The distance measuring device 1 having the image processing device 4 detects the parallax of the block BL on the in the first resolution right side image (step S30), and then limits the parallax searching range in the second resolution right side image having the predetermined second resolution by using the dynamic programming method on the basis of the parallax detection results of the blocks BL in the first resolution right side image having the predetermined first resolution (step S50).

This makes it possible for the parallax detection device 4 in the distance measuring device 1 to reduce the parallax searching range when the image having the predetermined second resolution which is higher than the predetermined first resolution by using the dynamic programming method. It is also possible to reduce the processing load to detect the parallax by using the dynamic programming method.

Further, the distance measuring device 1 having the image processing device 4 performs a sub pixel estimation of fitting the correlation, between the evaluation value M (xₘ, yₘ, xₛ), the block BLm and the parallax of the searching block BLs in the left side image, by using the fitting function, and detects the parallax of the block BLm on the basis of the sub pixel estimation (step S60). This makes it possible for the distance measuring device 1 having the image processing device 4 to detect the parallax with the sub pixel accuracy.

As previously described, the image processing device 4 corresponds to the parallax detection device, the process in step S10 corresponds to the image acquiring section for receiving the right side image and the left side image transmitted from the right side image acquiring device 2 and the left side image acquiring device 3. The process in step S30 corresponds to a low resolution image making section, the processes in step S210 to S270 and step S310 to S370 correspond to a first parallax detection section, and the process in step S60 corresponds to a second parallax detection section.

The right side image corresponds to the first image, and the left side image corresponds to the second image. The right side image having the predetermined first resolution and the right side image having the predetermined second resolution correspond to the first low resolution image. The left side image having the predetermined first resolution and the left side image having the predetermined second resolution correspond to the second low resolution image.

The block BL corresponds to the low resolution block, and the blocks BLₘ correspond to the resolution blocks.

The processes in steps S210 and S310 correspond to a node point arrangement section. The processes in steps S220 to S250, and steps S320 to S350 correspond to a cost calculation section. The processes in steps S260, S270, S360 and S370 correspond to a parallax determination section.

The cost D (p, uₚ) corresponds to the node point cost, the cost S (uₚ, u_{q}) corresponds to the parallax cost. The X direction moving cost Eₓ, the Y direction moving cost E_{y}, the right oblique direction moving cost E_{x-y}, and the left oblique direction moving cost E_{x+y} correspond to the movement direction moving costs.

The distance measuring device 1 having the image processing device 4 according to the exemplary embodiment has been explained. However, the concept of the present invention is not limited by this exemplary embodiment previously described. It is possible for the present invention to provide various modifications within the scope of the present invention.

### (First Modification)

The distance measuring device 1 uses the two image acquiring devices, i.e. the right side image acquiring device 2 and the left side image acquiring device 3. However, the concept of the present invention is not limited by this structure. For example, it is possible for the distance measuring device 1 to have not less than three image acquiring devices.

### (Second Modification)

The exemplary embodiment previously described has shown the right side image and the left side image acquired by the right side image acquiring device 2 and the left side image acquiring device 3 having different two resolutions. However, the concept of the present invention is not limited by this structure. For example, it is possible for the distance measuring device 1 to make the right side image and the left side image having a single low resolution, or not less than three low resolutions.

### (Third Modification)

As previously described, the distance measuring device 1 having the image processing device 4 according to the exemplary embodiment calculates the X direction moving cost Eₓ, the Y direction moving cost E_{y}, the right oblique direction moving cost E_{x-y}, and the left oblique direction moving cost E_{x+y}, adds them to obtain the total direction moving cost Eₛᵤₘ, and detects the parallax on the basis of the calculated total direction moving cost Eₛᵤₘ. However, the concept of the present invention is not limited by this structure. For example, it is possible for the distance measuring device 1 having the image processing device 4 to use, instead of using the total direction moving cost Eₛᵤₘ, a method of considering the X direction moving cost Eₓ, the Y direction moving cost E_{y}, the right oblique direction moving cost E_{x-y}, and the left oblique direction moving cost E_{x+y} so as to detect the parallax on the basis of these costs Eₓ, E_{y}, E_{x-y} and E_{x+y}.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not to limit the scope of the present invention which is to be given the full breadth of the following claims and all equivalents thereof.

What is claimed is:

1. A parallax detection device comprising:
a computer system including a central processing unit (CPU), the computer system being configured to provide:
an image acquiring section acquiring a first image and a second image, containing a same image acquiring area, simultaneously acquired at different locations by and transmitted from image acquiring devices;
a low resolution image making section converting the first image and the second image acquired by the image acquiring section to a first low resolution image and a second low resolution image, respectively, the first low resolution image having a predetermined low resolution and the second low resolution image having the predetermined low resolution, and the predetermined low resolution being lower than the resolution of each of the first image and the second image;
a first parallax detection section dividing the first low resolution image into a plurality of low resolution blocks, each of the low resolution blocks composed of a plurality of pixels, and the first parallax detection section detecting a parallax of each of the low resolution blocks by searching a low resolution corresponding block in the second low resolution image, for every low resolution block of the first low resolution image by using a dynamic programming method, the low resolution corresponding block having a region which is the same as the region of the low resolution block of the first low resolution image; and
a second parallax detection section dividing the first image acquired by the image acquiring section into a plurality of resolution blocks, each of the resolution blocks composed of a plurality of pixels,
the second parallax detection section determining a parallax of each of the resolution blocks by detecting a resolution corresponding block having a region which is the same as the region of the resolution block in the second image for every resolution block on the basis of a block matching method for searching the block having a high similarity of the resolution block in the second image, and
the second parallax detection section limiting the searching region to search the resolution corresponding blocks in the second image by using the block matching method on the basis of the parallax detection results detected by the first parallax detection section.

2. The parallax detection device according to claim 1, wherein the first parallax detection section comprises:
a node point arrangement section arranging node points in a node point space as a three dimensional space which is defined by a two dimensional position of the low resolution block and the parallax of the low resolution block, the node points being specified by the two dimensional position in the first low resolution image of the low resolution block and a parallax pf the low resolution block for every low resolution block, and
the node point arrangement section determining a node point cost of the node point, the node point cost being calculated to be reduced when increasing a similarity between the low resolution block corresponding to the node point and the low resolution corresponding block in the second low resolution image separated by the parallax of the node point;
a cost calculation section determining a parallax cost which increases when increasing a difference between a parallax of a first node point and a parallax of a second node point when the node point is moved from the first node point to the second node point in the node point space,
the cost calculation section determining a first moving path and a second moving path in the node point space, the first moving path being from a first start point located at an end of the node point space to an end point, the second moving path being from a second start point located at another end of the node point space opposite to the first start point to the end point, and
the cost calculation section calculating a first moving cost of the first moving path and a second moving cost of the second moving path, the first moving cost being a total sum of the node point cost of the node points present on the first moving path and the parallax cost of the first moving path, and the second moving cost being a total sum of the node point cost of the node points present on the second moving path and the parallax cost of the second moving path,
the cost calculation section determining a first minimum moving path having a minimum value of the first moving cost and a second minimum moving path having a minimum value of the second moving cost by using a dynamic programming method, and
the cost calculation section calculating a moving direction moving cost of the node point when the node point is moved in a direction specified on the basis of the first moving cost of the first minimum moving path and the second moving cost of the second minimum moving path; and
a parallax determination section determining, as the parallax of the low resolution block, the parallax of the node point having the minimum value of the moving direction moving cost in the plurality of the node points corresponding to the low resolution block for every low resolution block.

3. The parallax detection device according to claim 1, wherein
the cost calculation section calculates the moving direction moving cost in a plurality of different moving directions, and
the parallax determination section detects the parallax of the low resolution blocks on the basis of the moving direction moving cost calculated by the cost calculation section.

4. The parallax detection device according to claim 2, wherein
the cost calculation section calculates the moving direction moving cost in a plurality of different moving directions, and
the parallax determination section detects the parallax of the low resolution blocks on the basis of the moving direction moving cost calculated by the cost calculation section.

5. The parallax detection device according to claim 1, wherein
the low resolution image making section makes the first low resolution image and the second low resolution image with a different low resolution to each other, and
the first parallax detection section detects a parallax of each of the low resolution blocks in the order of ascending the resolution of the low resolution blocks, and limits a parallax range according to increasing a value of the low resolution to be used by the dynamic programming method, on the basis of the parallax detection result of the first parallax detection section when a value of the low resolution is low.

6. The parallax detection device according to claim 2, wherein
the low resolution image making section makes the first low resolution image and the second low resolution image with a different low resolution to each other, and
the first parallax detection section detects a parallax of each of the low resolution blocks in the order of ascending the resolution of the low resolution blocks, and limits a parallax range according to increasing a value of the low resolution to be used by the dynamic programming method, on the basis of the parallax detection result of the first parallax detection section when a value of the low resolution is low.

7. The parallax detection device according to claim 1, wherein the second parallax detection section detects a parallax of the resolution blocks by performing a sub pixel estimation of an evaluation value and a correlation on the basis of a predetermined fitting function when the second parallax detection section searches the resolution corresponding blocks by using the block matching method, where the sub pixel estimation presenting a similarity between the resolution blocks and the blocks in the second image, and the correlation being between the parallax of the resolution block and the parallax of the block in the second image.

8. The parallax detection device according to claim 2, wherein the second parallax detection section detects a parallax of the resolution blocks by performing a sub pixel estimation of an evaluation value and a correlation on the basis of a predetermined fitting function when the second parallax detection section searches the resolution corresponding blocks by using the block matching method, where the sub pixel estimation presenting a similarity between the resolution blocks and the blocks in the second image, and the correlation being between the parallax of the resolution block and the parallax of the block in the second image.
